(19) United States
(12) Patent Application Publication
(10) Pub. No.: US 2004/0012195 A1
(43) Pub. Date: Jan. 22, 2004

(54) Medical identification card, and apparatus for generating same

(75) Inventor: Ranjan Sachdev, Bethlehem, PA (US)

Correspondence Address: MORGAN, LEWIS & BOCKIUS LLP, 1701 MARKET STREET, PHILADELPHIA, PA, 19103-2921, US

(73) Assignee: Exscribe, Inc., Bethlehem, PA (US)

(21) Appl. No.: 10/396,075

(22) Filed: Mar. 25, 2003

(51) Int. Cl. B42D 15/00

(52) U.S. Cl. 283/75

(57) ABSTRACT

An identification card that carries information about an implant, medical device or prosthesis associated with a holder the card. The card includes a substrate that carries a computer-generated representation of a name of the holder; a type or name of the implant, medical device or prosthesis; characteristics of the implant, medical device or prosthesis; a place and date on which the implant, medical device or prosthesis was implanted, installed or given to the holder; and a surgeon or medical profession that implanted, installed or provided the implant, medical device or prosthesis to the holder. A computer implemented system for generating the cards is also provided.

### FIELD OF THE INVENTION

This invention relates to medical identification cards, and more particularly, to identification cards that carry information about an implant, medical device or prosthesis associated with a holder of the card. The present invention also relates to computer systems that automatically generate such cards in a customized fashion at the office of a medical professional that provides care to the holder of the card.

### BACKGROUND OF THE INVENTION

Patients receive medical implants and devices in connection with medical procedures. In addition, prostheses are provided to patients for limb replacements and the like. It is desirable for a patient receiving a medical implant, device or prosthesis to also have a corresponding identification card that identifies the patient, as well as information about the particular medical implant, device or prosthesis. Such an identification card would be useful in many instances including, for example, at an airport security checkpoint where the card holder's medical implant, device or prosthesis could potentially set-off a metal detector. Furthermore, it would be desirable if such identification cards could be easily and automatically produced in a customized fashion and distributed to patients where they are treated.

### SUMMARY OF THE INVENTION

The present invention is directed to an identification card that carries information about an implant associated with a holder the card. The card includes a substrate that carries a computer-generated representation of a name of the holder, a type or name of the implant, characteristics of the implant, a place and date on which the implant was surgically implanted in the holder, and a surgeon that implanted the implant in the holder. In further embodiments, the substrate carries computer-generated information identifying a manufacturer of the implant, a picture of the implant, a lot number associated with the implant, a size associated with the implant, a website link to educational materials associated with the implant, an image of a logo associated with the surgeon, and/or an address, phone number or website link associated with the surgeon.

In accordance with a further aspect, the present invention is directed to an identification card that carries information about a medical device associated with a holder the card. The card includes a substrate that carries a computer-generated representation of a name of the holder, a type or name of the medical device, characteristics of the medical device, a place and date on which the medical device was installed in the holder, and a medical profession that installed the medical device in the holder. In further embodiments, the substrate carries computer-generated information identifying a manufacturer of the medical device, a picture of the medical device, a lot number associated with the medical device, a size associated with the medical device, a website link to educational materials associated with the medical device, an image of a logo associated with the medical profession, and/or an address, phone number or website link associated with the medical professional.

In accordance with a still further aspect, the present invention is directed to an identification card that carries information about a prosthesis associated with a holder the card. The card includes a substrate that carries a computer-generated representation of a name of the holder, a type of the prosthesis, characteristics of the prosthesis, a place and date on which the prosthesis was given to the holder, and a medical profession that fitted the prosthesis for the holder. In further embodiments, the substrate carries computer-generated information identifying a picture of the prosthesis, a size associated with the prosthesis, a website link to educational materials associated with the prosthesis, an image of a logo associated with the medical profession, and/or an address, phone number or website link associated with the medical professional.

In any of the above embodiments, the computer-generated representation also may include a picture of the holder, an age of the holder, and/or an account number associated with the holder, and the computer-generated representation may correspond to bar-coded or human-readable information printed on the substrate.

In accordance with a still further aspect, the present invention is directed to a system for generating medical information cards. The system includes a plurality of user terminals each of which is located at an office of a different physician or medical professional. Each user terminal receives information representing a name of a patient; a type or name of implant, medical device or prosthesis associated with the patient; characteristics of the implant, medical device or prosthesis; a place and date on which the implant, medical device or prosthesis was surgically implanted, installed, or given to the patient; and a surgeon or medical professional that implanted, installed or gave the implant, medical device or prosthesis to the patient. Each user station automatically generates a medical information card containing a computer-generated representation of the information in a bar-coded and/or human-readable format. At least one database is coupled to each of the user terminals. The database stores information corresponding to each medical information card generated by the system. A plurality of verification stations are also coupled to the database. The verification stations function to verify information contained on a medical information card upon presentment of the card by a patient.

### BRIEF DESCRIPTION OF THE DRAWINGS

The accompanying drawings, which are incorporated herein and constitute part of this specification, illustrate the presently preferred embodiment of the invention, and, together with the general description given above and the detailed description given below, serve to explain features of the invention.

FIGS. 1A, 1B show the front and back, respectively, of a medical information card that carries information about an implant associated with the holder of the card, in accordance with an embodiment of the present invention.

FIGS. 2A, 2B show the front and back, respectively, of a medical information card that carries information about a medical device associated with the holder of the card, in accordance with a further embodiment of the present invention.

FIGS. 3A, 3B show the front and back, respectively, of a medical information card that carries information about a prosthesis associated with the holder of the card, in accordance with a still further embodiment of the present invention.

FIG. 4 shows a computer system for generating medical information cards in a customized fashion at the office of a medical professional that provides care to the holder of the card, in accordance with the present invention.

Throughout the figures, unless otherwise stated, the same reference numerals and characters denote like features, elements, components, or portions of the illustrated embodiments.

### DETAILED DESCRIPTION OF THE PREFERRED EMBODIMENT

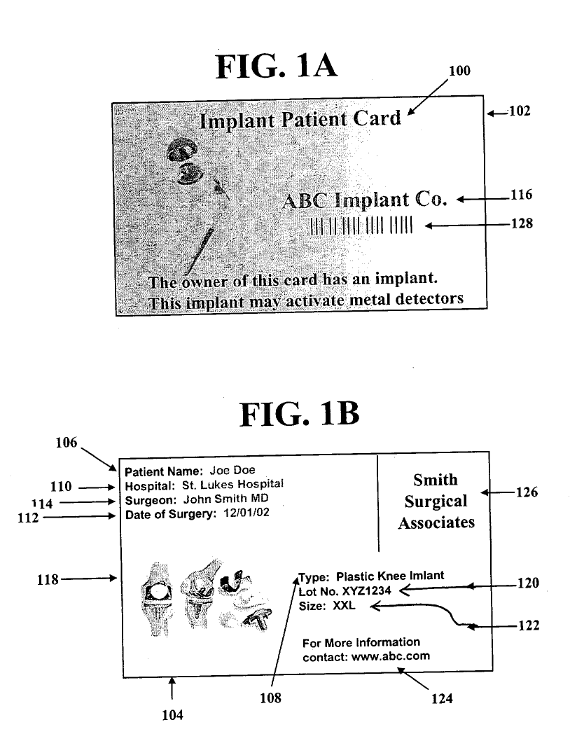

FIGS. 1A, 1B show the front 102 and back 104, respectively, of a medical information card 100 that carries information about an implant associated with the holder of the card. Card 100 preferably is sized like a credit card or driver's license card, such that it can be carried in the wallet of the holder. Card 100 may be formed from a plastic substrate, laminated paper or card stock, or any other suitable substrate material. The substrate carries a computer-generated representation of a name 106 of the holder of the card, a type or name 108 of the implant, characteristics of the implant (in the embodiment shown the characteristic is “plastic”), a place 110 and date 112 on which the implant was surgically implanted in the holder, and a surgeon 114 that implanted the implant in the holder. The substrate also optionally carries computer-generated information identifying a manufacturer 116 of the implant, a picture of the implant 118, a lot number 120 associated with the implant, a size 122 associated with the implant, a website link to educational materials associated with the implant 124, an image of a logo 126 associated with the surgeon, and/or an address (not shown), phone number (not shown) or website link (not shown) associated with the surgeon. A portion 128 of the human readable information shown on card 100 may also be printed in bar code format (or alternatively, encoded on a magnetic strip or using an RF ID tag) on card 100, in order to allow automatic identification of information carried on the card.

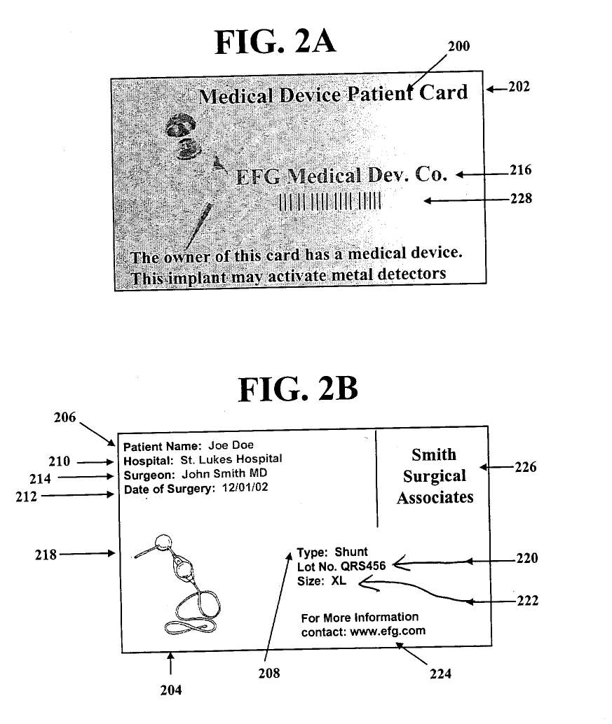

FIGS. 2A, 2B show the front 202 and back 204, respectively, of a medical information card 200 that carries information about a medical device associated with the holder of the card. Card 200 preferably is sized like a credit card or driver's license card, such that it can be carried in the wallet of the holder. Card 200 may be formed from a plastic substrate, laminated paper or card stock, or any other suitable substrate material. The substrate carries a computer-generated representation of a name 206 of the holder of the card, a type or name 208 of the medical device, a place 210 and date 212 on which the medical device was surgically implanted or installed in the holder, and a surgeon or medical professional 214 that implanted or installed the medical device in the holder. The substrate also optionally carries computer-generated information identifying a manufacturer 216 of the medical device, a picture of the medical device 218, a lot number 220 associated with the medical device, a size 222 associated with the medical device, a website link to educational materials associated with the medical device 224, an image of a logo 226 associated with the surgeon or medical professional, and/or an address (not shown), phone number (not shown) or website link (not shown) associated with the surgeon or medical professional. A portion 228 of the human readable information shown on card 200 may also be printed in bar code format (or alternatively, encoded on a magnetic strip or using an RF ID tag) on card 200, in order to allow automatic identification of information carried on the card.

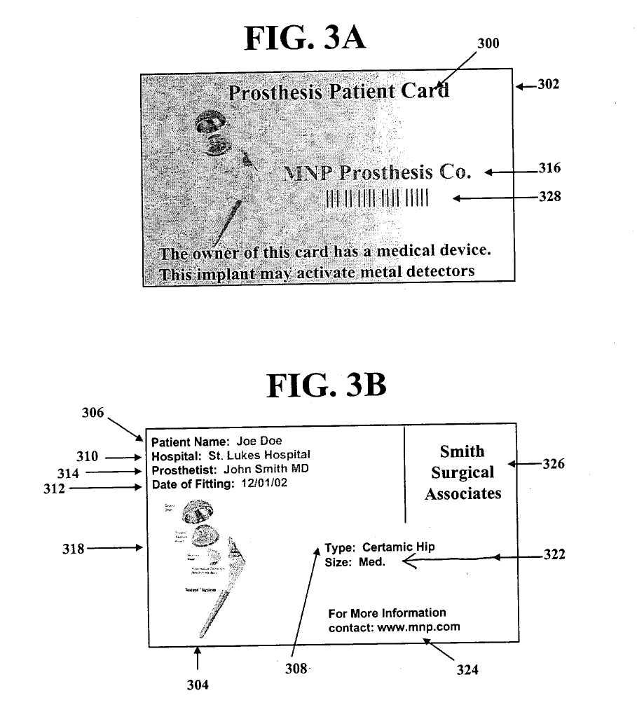

FIGS. 3A, 3B show the front 302 and back 304, respectively, of a medical information card 300 that carries information about a prosthesis associated with the holder of the card. Card 300 preferably is sized like a credit card or driver's license card, such that it can be carried in the wallet of the holder. Card 300 may be formed from a plastic substrate, laminated paper or card stock, or any other suitable substrate material. The substrate carries a computer-generated representation of the name of the holder 306, a type of the prosthesis 308, characteristics of the prosthesis (in the embodiment shown the characteristic is “ceramic”), a place 310 and date 312 on which the prosthesis was given to or fitted for the holder, a medical profession 314 that fitted the prosthesis for the holder, and a manufacturer 316 of the prosthesis. In further embodiments, the substrate carries computer-generated information identifying a picture 318 of the prosthesis, a size 322 associated with the prosthesis, a website link 324 to educational materials associated with the prosthesis, an image of a logo 326 associated with the medical profession, and/or an address (not shown), phone number (not shown) or website link (not shown) associated with the medical professional that fitted the prosthesis. A portion 328 of the human readable information shown on card 300 may also be printed in bar code format (or alternatively, encoded on a magnetic strip or using an RF ID tag) on card 300, in order to allow automatic identification of information carried on the card.

Referring now to FIG. 4, there is shown a computer system 400 for generating medical information cards (such as cards 100, 200 or 300) in a customized fashion at the office of a medical professional that provides care to the holder of the card, or implanted, installed or fitted an implant, medical device or prosthesis for the holder of the card, in accordance with the present invention. System 400 includes a plurality of user terminals 410 each of which is located at an office of a different physician or medical professional. In one embodiment, user terminals 410 each correspond to a networked personal computer, and include a database server 412 for storing information about patients that see the physician or medical professional at the office where the terminal 410 is located. Also, a printer 414 is coupled to each user terminal 410, in order to allow each user terminal 410 to automatically generate cards 100, 200, 300, bearing the customized information described above, at the particular office where the terminal is located. More particularly, each user terminal 410 receives information representing a name of a patient; a type or name of implant, medical device or prosthesis associated with the patient; characteristics of the implant, medical device or prosthesis; a place and date on which the implant, medical device or prosthesis was surgically implanted, installed, or given to the patient; and a surgeon or medical professional that implanted, installed or gave the implant, medical device or prosthesis to the patient. Such information is either retrieved from the local database server which stores information about patients in the office, input by an operator of user terminal 410, or retrieved from a manufacturer server 420. Each user station 410 automatically generates a medical information card 100, 200 or 300 containing a computer-generated representation of the customized information in a bar-coded and/or human-readable format, while the patient is present in the office, and the card is then provided to the patient (or holder.).

Each local server 412 includes a database that stores information corresponding to each medical information card generated by the system. Similarly information may be stored in manufacturer servers 420 (which each store information about identification cards issued to persons with implants or medical devices manufactured by a particular manufacturer), and at a central server 430 (which stores information about all identification cards issued by system 400).

A plurality of verification stations 440 are also coupled to the databases 412, 420, 430. The verification stations 440 may be positioned, for example, at airport security checkpoints, and function to verify information contained on a medical information card 100, 200, 300 upon presentment of the card by a patient or holder. Each verification station 440 is adapted to compare the information printed in human-readable or bar coded format on the card to information stored in one or more of the databases, in order to confirm that the card is true and authentic.

While the principles of the invention have been described above in connection with the specific apparatus and associated methods set forth above, it is to be clearly understood that the above description is made only by way of example and not as a limitation on the scope of the invention as defined in the appended claims.

What is claimed is:

1. An identification card that carries information about an implant associated with a holder the card, comprising:
a substrate that carries a computer-generated representation of:
a name of the holder,
a type or name of the implant;
characteristics of the implant;
a place and date on which the implant was surgically implanted in the holder; and
a surgeon that implanted the implant in the holder.

2. An identification card according to claim 1, wherein the substrate further carries computer-generated information identifying a manufacturer of the implant.

3. An identification card according to claim 1, wherein the substrate further carries a computer-generated picture of the implant.

4. An identification card according to claim 1, wherein the substrate further carries computer-generated information identifying a lot number associated with the implant.

5. An identification card according to claim 1, wherein the substrate further carries computer-generated information identifying a size associated with the implant.

6. An identification card according to claim 1, wherein the substrate further carries a website link to education materials associated with the implant.

7. An identification card according to claim 1, wherein the substrate further carries a computer-generated picture of the holder.

8. An identification card according to claim 1, wherein the substrate further carries computer-generated information indicating an age of the holder.

9. An identification card according to claim 1, wherein the substrate further carries computer-generated information indicating an account number associated with the holder.

10. An identification card according to claim 1, wherein the substrate further carries computer-generated image of a logo associated with the surgeon.

11. An identification card according to claim 1, wherein the substrate further carries computer-generated information identifying an address, phone number or website link associated with the surgeon.

12. An identification card according to claim 1, wherein at least a portion of the computer-generated representation corresponds to bar-coded information printed on the substrate.

13. An identification card according to claim 1, wherein at least a portion of the computer-generated representation corresponds to human-readable information printed on the substrate.

14. An identification card that carries information about a medical device associated with a holder the card, comprising:
a substrate that carries a computer-generated representation of:
a name of the holder,
a type or name of the medical device;
characteristics of the medical device;
a place and date on which the medical was installed in the holder; and
a medical profession that installed the medical device in the holder.

15. An identification card according to claim 14, wherein the substrate further carries computer-generated information identifying a manufacturer of the medical device.

16. An identification card according to claim 14, wherein the substrate further carries computer-generated picture of the medical device.

17. An identification card according to claim 14, wherein the substrate further carries computer-generated information identifying a lot number associated with the medical device.

18. An identification card according to claim 14, wherein the substrate further carries computer-generated information identifying a size associated with the medical device.

19. An identification card according to claim 14, wherein the substrate further carries a website link to education materials associated with the medical device.

20. An identification card according to claim 14, wherein the substrate further carries a computer-generated picture of the holder.

21. An identification card according to claim 14, wherein the substrate further carries computer-generated information indicating an age of the holder.

22. An identification card according to claim 14, wherein the substrate further carries computer-generated information indicating an account number associated with the holder.

23. An identification card according to claim 14, wherein the substrate further carries computer-generated image of a logo associated with the medical professional.

24. An identification card according to claim 14, wherein the substrate further carries computer-generated information identifying an address, phone number or website link associated with the medical professional.

25. An identification card according to claim 14, wherein at least a portion of the computer-generated representation corresponds to bar-coded information printed on the substrate.

26. An identification card according to claim 14, wherein at least a portion of the computer-generated representation corresponds to human-readable information printed on the substrate.

27. An identification card that carries information about a prosthesis associated with a holder the card, comprising:
a substrate that carries a computer-generated representation of:
a name of the holder,
a type of the prosthesis;
characteristics of the prosthesis;
a place and date on which the prosthesis was given to the holder; and
a medical professional that fitted the prosthesis for the holder.

28. An identification card according to claim 27, wherein the substrate further carries computer-generated picture of the prosthesis.

29. An identification card according to claim 27, wherein the substrate further carries computer-generated information identifying a size associated with the prosthesis.

30. An identification card according to claim 27, wherein the substrate further carries a website link to education materials associated with the prosthesis.

31. An identification card according to claim 27, wherein the substrate further carries a computer-generated picture of the holder.

32. An identification card according to claim 27, wherein the substrate further carries computer-generated information indicating an age of the holder.

33. An identification card according to claim 27, wherein the substrate further carries computer-generated information indicating an account number associated with the holder.

34. An identification card according to claim 27, wherein the substrate further carries computer-generated image of a logo associated with the medical professional.

35. An identification card according to claim 27, wherein the substrate further carries computer-generated information identifying an address, phone number or website link associated with the medical professional.

36. An identification card according to claim 27, wherein at least a portion of the computer-generated representation corresponds to bar-coded information printed on the substrate.

37. An identification card according to claim 27, wherein at least a portion of the computer-generated representation corresponds to human-readable information printed on the substrate.

38. A system for generating medical information cards, comprising:
a plurality of user terminals each of which is located at an office of a different physician; wherein each user terminal receives information representing a name of a patient, a type or name of implant associated with the patient, characteristics of the implant, a place and date on which the implant was surgically implanted in the patient, and a surgeon that implanted the implant in the patient; and wherein each user station automatically generates a medical information card containing a computer-generated representation of the information;
a database, coupled to each of the user terminals; wherein the database stores information corresponding to each medical information card generated by the system; and
a plurality of verification stations, coupled to the database, for verifying information contained on a medical information card upon presentment of the card by a patient.

39. A system for generating medical information cards, comprising:
a plurality of user terminals each of which is located at an office of a different physician; wherein each user terminal receives information representing a name of a patient, a type or name of medical device associated with the patient, characteristics of the medical device, a place and date on which the medical was installed in the patient, 10 and a medical profession that installed the medical device in the patient; and wherein each user station automatically generates a medical information card containing a computer-generated representation of the information;
a database, coupled to each of the user terminals; wherein the database stores information corresponding to each medical information card generated by the system; and
a plurality of verification stations, coupled to the database, for verifying information contained on a medical information card upon presentment of the card by a patient.

40. A system for generating medical information cards, comprising:
a plurality of user terminals each of which is located at an office of a different physician; wherein each user terminal receives information representing a name of a patient, a type of prosthesis associated with the patient, characteristics of the prosthesis, a place and date on which the prosthesis was given to the patient, and a medical professional that fitted the prosthesis for the holder; and wherein each user station automatically generates a medical information card containing a computer-generated representation of the information;
a database, coupled to each of the user terminals; wherein the database stores information corresponding to each medical information card generated by the system; and
a plurality of verification stations, coupled to the database, for verifying information contained on a medical information card upon presentment of the card by a patient.
